(19) United States
(12) Patent Application Publication
(10) Pub. No.: US 2007/0252835 A1
(43) Pub. Date: Nov. 1, 2007

(54) Methods and systems for interactive signal analysis

(76) Inventors: Per Kangru, Fredriksberg (DK); Juergen Voss, Wiesbaden (DE)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/412,477

(22) Filed: Apr. 26, 2006

(51) Int. Cl. G06T 11/20

(52) U.S. Cl. 345/440

(57) ABSTRACT

Graphical user interfaces, methods and systems that enable the selection, grouping and analysis of data.

### BACKGROUND OF THE INVENTION

As the use of networks increases, especially in telecommunications, network system providers face conflicting demands from the customer, who demands increase network reliability and performance, and from the business environment, which is sensitive to the cost of operating and maintaining the higher level of service. In order to satisfy or balance those demands, network analysis systems have been developed to facilitate the planning, troubleshooting, installing, and maintaining present-day networks.

Many network analysis systems have a graphical user interface that displays data in the network grouped by data session or by independent network events. A number of these groups can be displayed along with characteristics of the data. The display enables the identification of errors. In conventional network analysis systems, it is possible to the display information corresponding to communication events in a network communications session. In conventional network analysis systems, it is also possible to display graphically measures of performance of the communications session as a function of the time events. However, conventional network analysis systems, there is no indication of the communication event corresponding to a value of the measures of performance in the graphical display. Therefore, there is a need for improved graphical user interfaces.

### SUMMARY OF THE INVENTION

In one instance, the graphical user interface of this invention includes a component capable of selecting criteria from a structured collection of data, the structured collection of data including criteria for selecting properties of acquired information, and, a portion (such as, in one embodiment, but not limited to, a list) of the acquired information, the portion displayed on a display device and satisfying criteria selected by use of the component.

In one embodiment, the acquired information includes signaling messages and the criteria include filters for analyzing the signaling messages.

In another instance, a computer readable medium has computer readable code embodied therein that causes a computer to implement the graphical user interface of this invention.

Methods and systems for implementing the present invention are also disclosed.

For a better understanding of the present invention, together with other and further objects thereof, reference is made to the accompanying drawings and detailed description and its scope will be pointed out in the appended claims.

### BRIEF DESCRIPTION OF THE DRAWINGS

FIGS. 1a, 1b are graphical depictions of a user interface in a conventional network analysis system;

FIG. 2 is a graphical depiction of an embodiment of the user interface of this invention;

FIG. 3 is a graphical schematic representation of a flowchart of an embodiment of the method of this invention;

FIG. 4 is a graphical schematic representation of a flowchart of another embodiment of the method of this invention; and

FIG. 5 is a graphical schematic representation of a block diagram of an embodiment of the system of this invention.

### DETAILED DESCRIPTION OF THE INVENTION

Graphical user interfaces, methods and systems that enable the display of a communication event in a network communications session corresponding to a datum in a line graph are disclosed herein below.

In one instance, the graphical user interface of this invention includes at least one line graph depicting data corresponding to a network communication session, the data being depicted as a function of an independent variable, a component capable of selecting a communication event corresponding to a datum from the data, and, a component capable of displaying information identifying the corresponding communication event.

In another instance, a computer readable medium has computer readable code embodied therein that causes a computer to implement the graphical user interface of this invention.

“Component” as used herein refers to means for accomplishing a desired function. Typically, such means as implemented in software. In one instance, such means are means for displaying data in graphical user interfaces (GUIs) such as text boxes or means for selecting options in graphical user interfaces (GUIs) such as, but not limited to, menus, pull down menus, drag and drop between dialog boxes, and other selecting means (see, for example, C. Petzold, Programming Windows, ISBN 1-57231-995-X, Ch. 9, Ch. 10, Ch. 11, pp. 357-566, which are incorporated by reference herein).

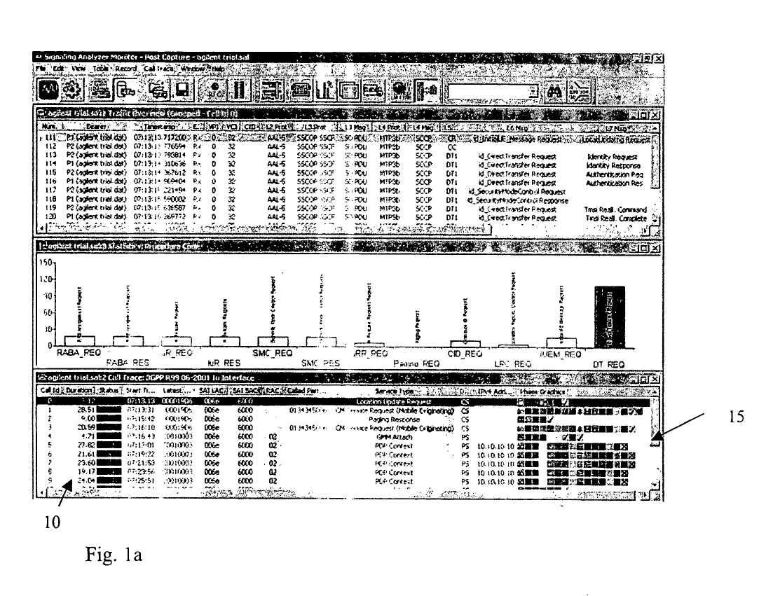

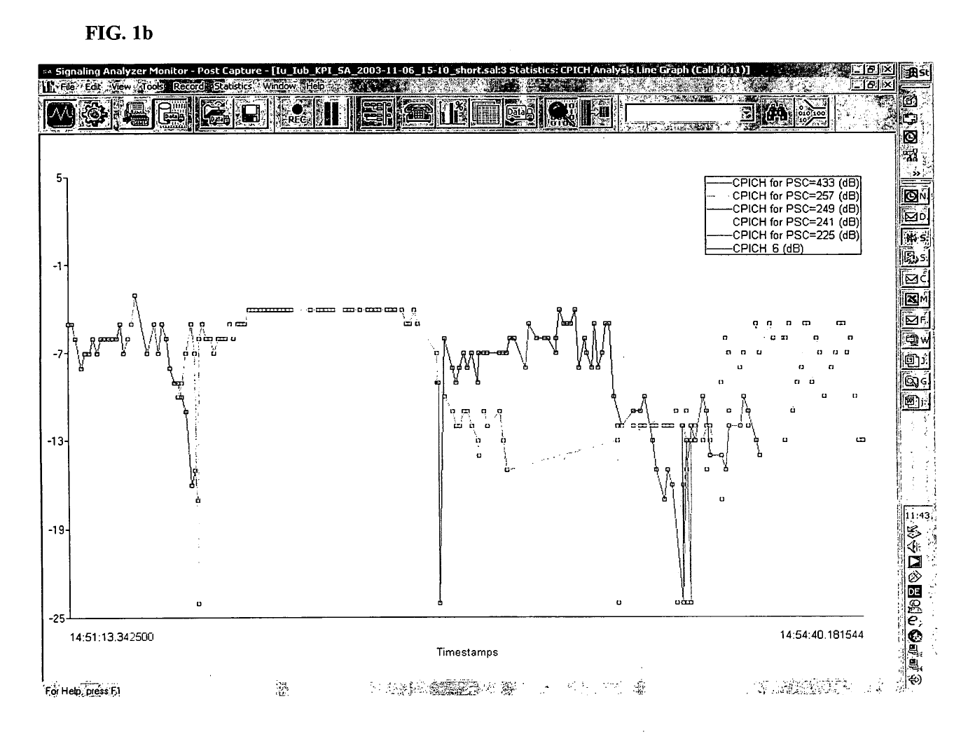

In order to elucidate the description of the user interface of this invention, a description of a user interface of a conventional signal (network) analysis system, wherein the acquired information includes communication events (signaling messages) from a network communications session, is presented below. A user interface of a conventional signal analysis system is shown in FIGS. 1a, 1b. Referring to FIG. 1a, characteristics 10 for a number of signaling messages (wireless telephone calls in the example shown) are displayed in a Call Trace window 15. Referring FIG. 1b, data for a number of performance measures for the communications session is depicted in line graphs as a function of an independent variable (timestamps in the example shown).

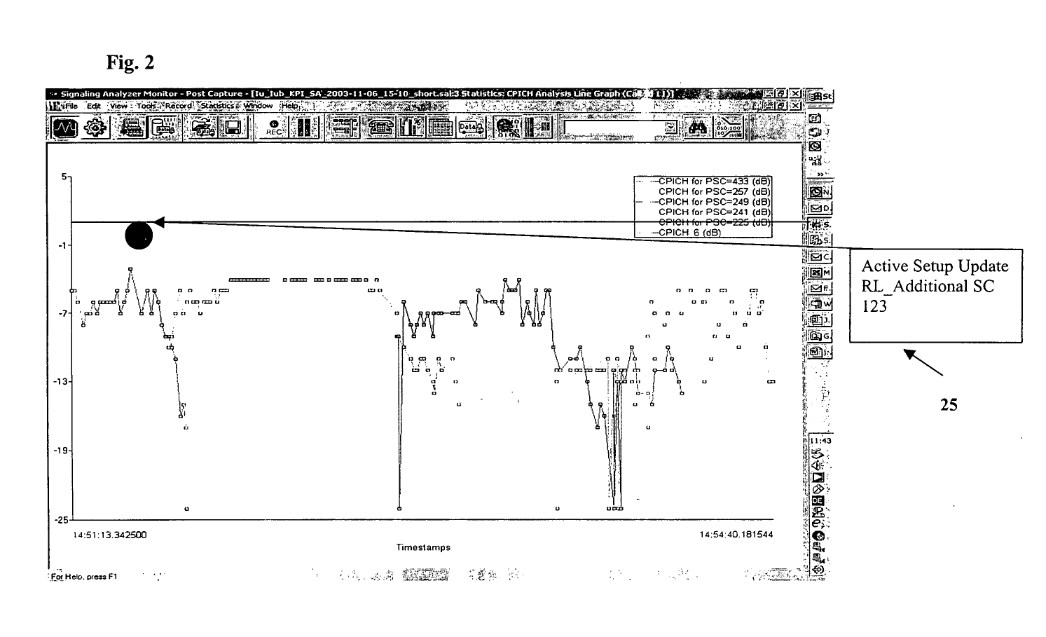

In an embodiment of the user interface of this invention, shown in FIG. 2, the user interface includes, in addition to the line graphs, a component that selects the communication event corresponding to a datum for the data, and another component that is capable of displaying information identifying the communication event corresponding to the datum. In one embodiment, this invention not been limited only to this embodiment, the first component constructs a “table” where each entry in the table consists of a datum (or a value of the independent variable) and information identifying the communication event corresponding to the datum. The second component, in this embodiment, consists of means of selecting the datum, such as a pointer to the datum in the line graph or to the independent variable in the line graph where pointing to a point in the line graph selects the datum (or the value of the independent variable), retrieves the datum (or the value of the independent variable), provides that value to the table, returns the information identifying the communication event corresponding to the datum, and displays the information in a text box 25. The above described components can, in one embodiment, be implemented in software.

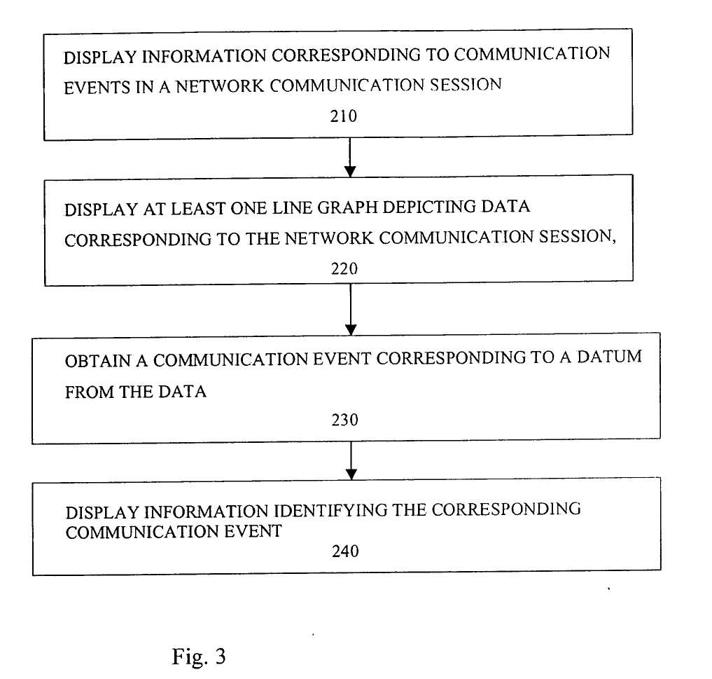

An embodiment of the method of this invention is shown in FIG. 3. Referring to FIG. 3, information is displayed corresponding to communication events in a network communication session (step 210, FIG. 3) and at least one line graph depicting data corresponding to the network communication session is also displayed (step 220, FIG. 3) the data being depicted as a function of an independent variable. A communication event corresponding to a datum from the data is obtained (step 230, FIG. 3) and the information identifying the corresponding communication event is also displayed (step 240, FIG. 3).

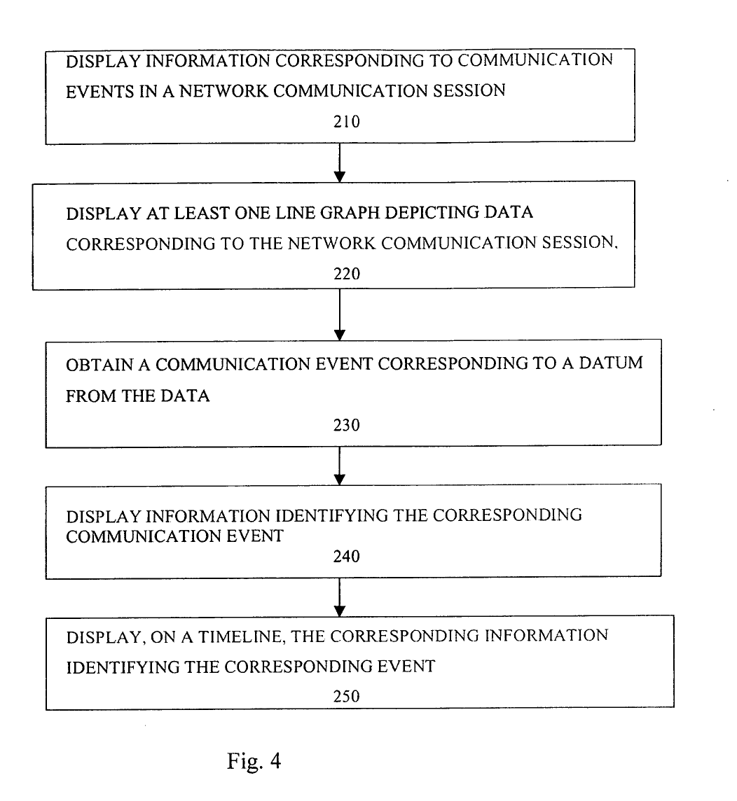

In a further embodiment of the method of this invention, shown in FIG. 4, the independent variable is a time variable and the method includes the step of displaying on a timeline the corresponding information identifying the corresponding event (step 250, FIG. 4). Application of this embodiment of the method in a user interface is shown in FIG. 2, where input means can be, in one embodiment, “mouse clicks” and output can be by means of an output component, a text box in the embodiment shown (see, for example, C. Petzold, Programming Windows, ISBN 1-57231-995-X, Ch. 9, Ch. 10, Ch. 11, pp. 273-326, pp. 357-566, which are incorporated by reference herein).

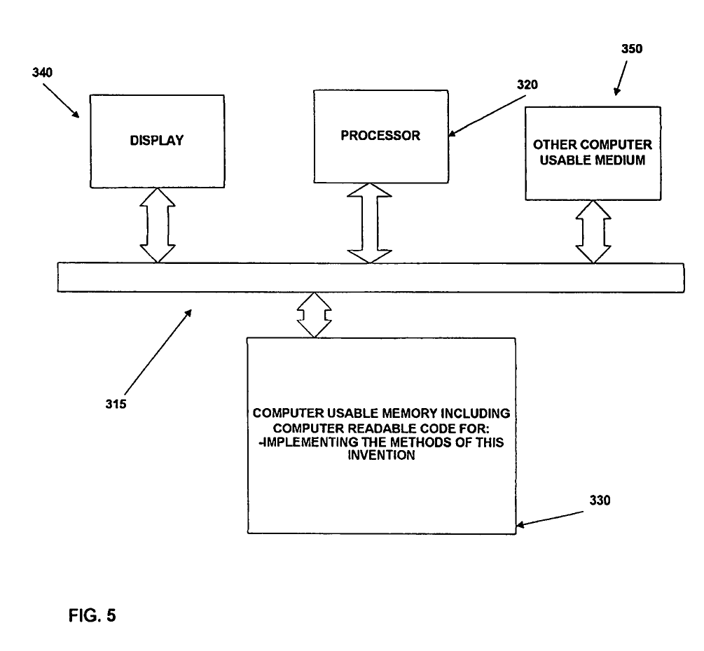

A schematic block diagram representation of an embodiment of the system of this invention is shown in FIG. 5. The embodiment of the system of this invention shown in FIG. 5 includes one or more processors 320, a display device 340, and a computer usable medium (memory) 330. The computer usable memory 330 as computer readable code embodied therein that is capable of causing the one or more processors 320 to provide a user interface for depiction in the display device 340, the user interface comprising a component capable of selecting criteria from a structured collection of data, where the structured collection of data comprises criteria for selecting properties of acquired signaling messages, and to display, upon user input, a subset of the acquired signaling messages, the subset satisfying the selected criteria. In one instance, but not a limitation of this invention, the computer readable code, which causes the one or more processors 320 to provide the user interface, is generated starting from a higher-level language utilizing the application program interface (API) of the operating system being used (for example, but not limited to, the Windows API).

In one embodiment, the computer readable code can also cause the one or more processors 320 to update the structured collection of data and, to update the component capable of selecting criteria from the structured collection of data, where the updated component is capable of selecting criteria from the updated structured collection of data.

In another embodiment, the computer readable code can also cause the one or more processors 320 to update the component capable of selecting criteria from the structured collection of data. For example, the present invention not being limited to only this example, in the embodiment in which the acquired information comprises signaling messages and structured collection of data includes filters for selecting properties of the acquired signaling messages, one or more of filters could be deselected from the component (for example, a drop-down menu). As stated above, the user can deselect filters by means of, for example, a checkbox next to the filter name in the component (for example, a drop-down menu) or by “right clicking” on the filter name and obtaining a control menu allowing deselecting of the filter or any other method provided by the API for selecting or deselecting a choice (criterion) in a component. After the component has been updated, if desired, the structured collection of data can be also updated.

The embodiment of the system of this invention shown in FIG. 5 also includes one or more other computer memories (computer usable media) 350, which in one instance can store the structured collection of data in a database. The display element 340, the one or more processors 320, the computer usable medium 330, and the other computer usable medium 350 are operatively connected by means of a connection component 315 (the connection component may be, for example, a computer bus, or a carrier wave).

It should be noted that the one or more computer usable media 330 and the one or more all her computer usable media 350 can be the same computer usable media. That is, the computer readable code and the structured collection of data may be stored in the same physical memory (computer usable medium).

The techniques described above may be implemented in one or more computer programs executing on a programmable computer including a processor, a storage medium readable by the processor (including, for example, volatile and non-volatile memory and/or storage elements), and, in some embodiments, also including at least one input device, and/or at least one output device. Program code may be applied to data entered using the input device (or user interface) to perform the functions described and to generate output information. The output information may be applied to one or more output devices.

Elements and components described herein may be further divided into additional components or joined together to form fewer components for performing the same functions.

Each computer program may be implemented in any programming language, such as assembly language, machine language, a high-level procedural programming language, an object-oriented programming language, or a combination thereof. The programming language may be a compiled or interpreted programming language.

Each computer program may be implemented in a computer program product tangibly embodied in a computer-readable storage device for execution by a computer processor. Method steps of the invention may be performed by a computer processor executing a program tangibly embodied on a computer-readable medium to perform functions of the invention by operating on input and generating output.

Common forms of computer-readable (computer usable) media include, for example, a floppy disk, a flexible disk, hard disk, magnetic tape, or any other magnetic medium, a CDROM, any other optical medium, punched cards, paper tape, any other physical medium with patterns of holes or other patterns, a RAM, a PROM, and EPROM, a FLASH-EPROM, any other memory chip or cartridge, a carrier wave, such as electromagnetic radiation or electrical signals, or any other medium from which a computer can read.

Although the invention has been described with respect to various embodiments, it should be realized this invention is also capable of a wide variety of further and other embodiments within the spirit and scope of the appended claims.

What is claimed is:

1. A user interface for depicting on a display device, the user interface comprising:
at least one line graph depicting data corresponding to a network communication session, the data being depicted as a function of an independent variable;
a component capable of selecting a communication event corresponding to a datum from the data; and
a component capable of displaying information identifying the corresponding communication event.

2. The user interface of claim 1 wherein the independent variable is a time variable.

3. The user interface of claim 2 wherein the corresponding information identifying the corresponding event are displayed on a timeline.

4. A computing device and associated display device, the computing device being programmed to implement the user interface of claim 1.

5. A computer readable medium having computer executable code embodied therein, said computer executable code being capable of causing a computer to implement the user interface of claim 1.

6. A method for displaying information on acquired signaling messages, the method comprising the steps of:
displaying information corresponding to communication events in a network communication session;
displaying at least one line graph depicting data corresponding to the network communication session, the data being depicted as a function of an independent variable;
obtaining a communication event corresponding to a datum from the data; and
displaying information identifying the corresponding communication event.

7. The method of claim 6 wherein the independent variable is a time variable.

8. The method of claim 7 further comprising the step of:
displaying, on a timeline, the corresponding information identifying the corresponding event.

9. A system for analyzing and displaying acquired signaling messages, the system comprising:
at least one processor;
a display device;
at least one computer usable medium having computer readable code embodied there in, said computer readable code being capable of causing said at least one processor to:
provide a user interface for depiction in the display device, the user interface comprising:
at least one line graph depicting data corresponding to a network communication session, the data being depicted as a function of an independent variable;
a component capable of obtaining a communication event corresponding to a datum from the data; and
a component capable of displaying information identifying the corresponding communication event,
display, using the display device and upon user input, the communication event corresponding to the datum from the data.

10. The system of claim 9 wherein said computer usable code is also capable of causing said at least one processor to:
display, using the display device, information corresponding to communication events in the network communication session.

11. The system of claim 9 wherein the independent variable is a time variable.

12. The system of claim 11 wherein said computer usable code is also capable of causing said at least one processor to:
display on a timeline the corresponding information identifying the corresponding event.
